(19) United States
(12) Patent Application Publication
(10) Pub. No.: US 2004/0018275 A1
(43) Pub. Date: Jan. 29, 2004

(54) Carbonated energy beverage

(75) Inventors: Daniel Joseph Kochakji, West Milford, NJ (US); Gert Willem Meijer, Mahwah, NJ (US); Nikki Omolara Craig, Avenel, NJ (US); Reginaldus Petrus Josephus Van Der Wielen, De Bilt (NL)

Correspondence Address: UNILEVER, PATENT DEPARTMENT, 45 RIVER ROAD, EDGEWATER, NJ, 07020, US

(73) Assignee: Unilever Bestfoods

(21) Appl. No.: 10/200,963

(22) Filed: Jul. 23, 2002

(51) Int. Cl. A23L 1/30

(52) U.S. Cl. 426/72

(57) ABSTRACT

An energy-delivering carbonated beverage with B-complex vitamins and a dextrorotatory saccharide is described. The beverage has excellent taste characteristics, is not salty, and delivers an excellent energy boost when consumed in predetermined amounts.

### FIELD OF THE INVENTION

The present invention is directed to a fast or enhanced energy-delivering beverage. More particularly, the invention is directed to a beverage that comprises a dextrorotatory saccharide, vitamins and, for example, fruit juice, whereby the beverage is carbonated and microbiologically stable, preferably without being pasteurized.

### BACKGROUND OF THE INVENTION

Beverages (e.g., sports drinks) that contain sugars, electrolytes, minerals and amino acids have been formulated. These types of beverages are designed to give some energy enhancement to athletes engaged in sports activities. Also, they are designed to minimize the impact of mild dehydration by replenishing the body with minerals and electrolytes.

The above-described sports drinks, however, often do not deliver, to fatigue individuals, the appropriate amount of energy on demand. Additionally, many conventional sports drinks are typically classified as not having a terrific taste, and such drinks can taste salty, a direct result of their isotonic nature.

It is of increasing interest to develop a high energy-delivering beverage that tastes good, is not salty, and fortified with vitamins. The present invention, therefore, is directed to an energy-delivering beverage that comprises a dextrorotatory saccharide, vitamins and, for example, fruit juice, whereby the beverage is carbonated and microbiologically stable without being pasteurized. Surprisingly, such a beverage delivers high energy to the consumer, even when the beverage is formulated substantially free of electrolytes.

Additional Information

Efforts have been disclosed for making performance drinks. In U.S. Pat. No. 5,980,968, drinks having copolymers of sucrose and epichlorohydrin are described.

Other efforts have been disclosed for making beverages. In U.S. Pat. No. 6,277,427, beverages with a stimulating effect are described.

Still, other efforts have been disclosed for making beverages. In U.S. Pat. No. 6,296,892, beverages for enhanced physical performance are described.

None of the additional information above describes an energy-delivering carbonated beverage that has dextrorotatory saccharide, vitamins and, for example, fruit juice that tastes great and is microbiologically stable even without being pasteurized. Moreover, none of the additional information above describes an energy-delivering beverage that is substantially free of electrolytes and suitable to deliver energy on demand to fatigue individuals.

### SUMMARY OF THE INVENTION

In a first aspect, the present invention is directed to an energy-delivering beverage comprising:

(a) from about 4.0% to about 25.0% by weight of a dextrorotatory saccharide;

(b) at least about 3.0% by weight of at least one concentrate selected from the group consisting of a tea, coffee, fruit and vegetable concentrate, the concentrate not to exceed an amount that makes the energy-delivering beverage more than about 85.0% by weight coffee liquid, tea liquid, fruit juice or vegetable juice;

(c) an effective amount of carbon dioxide to carbonate the beverage, the effective amount of carbon dioxide not to exceed about 3.0 liters of carbon dioxide for about every 1.0 liter of beverage; and

(d) a mixture of vitamins comprising at least about 10.0% of the recommended daily allowance of B complex vitamins and at least about 10.0% of the recommended daily allowance of a water soluble vitamin

wherein the energy-delivering beverage comprises an energy factor of about ≧250.0.

In a second aspect, the present invention is directed to a kit comprising the energy-delivering beverage of the first aspect of the invention with instructions to consume the beverage for an energy boost.

Energy factor, as used herein, is defined to mean the weight percent of dextrorotatory saccharide/the weight percent of B complex vitamins in the energy-delivering beverage, based on total weight of the energy-delivering beverage. In an especially preferred embodiment, the energy-delivering beverage of this invention has an energy factor of about ≧700.0.

Tea, as used herein, is meant to include tea derived from Camillia sinensis, as well as herbal teas.

Coffee, as used herein, is defined to mean a beverage derived from a coffee bean, including ground coffee.

Concentrate is meant to mean a precursor suitable to produce coffee liquid, tea liquid, fruit juice or vegetable juice when combined with about 75.0% to about 99.0% by weight water.

Coffee liquid is meant to mean coffee suitable for drinking and tea liquid is meant to mean tea suitable for drinking.

Fruit can include, for example, an apple, lime, lemon, orange, grapefruit, pear, grape, blackberry, raspberry, strawberry, banana, blueberry, kiwi and tomato, and vegetable, for example, can include a carrot, celery, cucumber and parsley.

Substantially free of electrolytes means less than about 5.0%, and preferably, less than about 1.0% by weight of the energy-delivering beverage comprises a component added as an electrolyte. In a most preferred embodiment, the energy-delivering beverage of this invention comprises no component added as an electrolyte.

### DETAILED DESCRIPTION OF THE PREFERRED EMBODIMENTS

The only limitation with respect to the dextrorotatory saccharide that may be used in this invention is that it is a saccharide that may be used in a beverage suitable for human consumption. Such a saccharide (preferably a monosaccharide or disaccharide) can include glucose, fructose, galactose, lactose, mannose, ribose, erythrose, sucrose and mixtures thereof. The dextrorotatory saccharides that may be used in the energy-delivering beverage of this invention are made commercially available from suppliers like Corn Products International and AE Staley.

Regarding the total amount of dextrorotatory saccharide used in this invention, typically from about 4.0% to about 25.0%, and preferably, from about 4.5% to about 15.0% by weight dextrorotatory saccharide may be used, based on total weight of the energy-delivering beverage, and including all ranges subsumed therein. In an especially preferred embodiment, the dextrorotatory saccharide used in this invention is D-glucose or dextrose, whereby at least about 5.0% to about 10.0% by weight of the energy-delivering beverage is dextrose and at least about 85.0% of the total weight of dextrorotatory saccharide in the energy-delivering beverage is not supplied with flavors (including flavor concentrate) and high fructose corn syrup.

The concentrate employed in this invention can be a coffee, tea, fruit or vegetable concentrate as well as a mixture of the same. Such a concentrate, when combined with about 75.0% to about 95.0%, and preferably, from about 80.0% to about 90.0% by weight water can yield coffee liquid, tea liquid, fruit juice and vegetable juice, as the case may be, suitable for consumption.

In the present invention, at least about 10.0%, and preferably, at least about 20.0%, and most preferably, at least about 30.0%, by weight of the energy-delivering beverage is coffee liquid, tea liquid, vegetable juice or fruit juice, as the case may be, wherein the amount of the same in the energy-delivering beverage does not exceed more than about 85.0% by weight, based on total weight of the energy-delivering beverage.

The concentrates employable for use in the present invention are commercially available from suppliers like Imperial Frozen Foods, Inc., Hig & White, Brothers International, Unilever Bestfoods and Liquid Coffee, Inc.

Carbon dioxide is the preferred soluble gas that may be pumped into the energy-delivering beverage of the present invention. Beverage grade carbon dioxide is especially preferred and often made available from suppliers like Praxair, Inc. and Koch Industries, Inc.

When pumping carbon dioxide into the energy-delivering beverage of the present invention, the carbon dioxide may be added at any time during the production of the energy-delivering beverage. In a preferred embodiment, however, carbon dioxide is pumped into the energy-delivering beverage after all components of the beverage are combined. In a most preferred embodiment, from about 0.5 to about 3.0 liters of carbon dioxide are added for about every 1.0 liter of beverage.

Regarding the mixture of vitamins suitable for use in this invention, such vitamins comprise at least about 10.0%, and preferably, at least about 20.0% to about 50.0% of the recommended daily allowance of B complex vitamins, including all ranges subsumed therein. The mixture of vitamins also includes at least about 10.0%, and preferably, at least about ⁷5.0%, and most preferably, at least about 90.0% to about 100.0% of the recommended daily allowance of a water soluble vitamin, like vitamin C, and water soluble vitamin E or a mixture thereof.

Additives that may be employed in the energy-delivering beverage of the present invention include corn syrup, like high fructose corn syrup; flavors, like natural and artificial flavors; acids (for pH modification), like citric acid, acetic acid, phosphoric acid and malic acid; preservatives like ethylene diamine tetracetic acid and those generally classified as benzoates, sorbates, phosphates and mixtures thereof.

Typically, the total amount of additives used in the energy-delivering beverage of the present invention does not exceed about 6.5% by weight, based on total weight of the energy-delivering beverage. In a preferred embodiment, however, from about 2.5% to about 5.0% by weight high fructose corn syrup is used to formulate the energy-delivering beverage of the present invention, along with at least about 0.002% to about 0.20%, and preferably, from about 0.09% to about 0.125% by weight preservative, based on total weight of the energy-delivering beverage. The amount of acid used in the energy-delivering beverage of this invention typically results in the beverage having a pH of from about 2.5 to about 3.8, and preferably, from about 2.9 to about 3.5.

The preparation of the energy-delivering beverage of the present invention is limited only to the extent that after the components (e.g., water, dextrorotatory saccharide, fruit juice) are combined and mixed, a beverage suitable for human consumption is made. In a preferred embodiment, however, the components of the energy-delivering beverage of this invention are mixed with water at a temperature that is greater than about 60° C. but that does not exceed about 72.5° C. to produce a beverage premix which is then combined with cool water (and subsequently carbonated to make the final energy-delivering beverage) at a temperature of less than about 6.5° C. such that the amount of cool water employed to make the energy-delivering beverage is about 5 to about 10 times the amount of water used to make the beverage premix. The superior energy-delivering beverage of the present invention, therefore, tastes great and is surprisingly stable in the absence of pasteurization (i.e., no heating steps exceeding about 80° C.). However, it should be known that if desired, the energy-delivering beverage of this invention can be pasteurized.

When selling or marketing the energy-delivering beverage of the present invention, the beverage may be sold as a package or kit with instructions to consume about 15.0 grams to about 30.0 grams, and preferably, from about 18.0 grams to about 22.0 grams of dextrose per serving (preferably between meals) for a maximum energy boost. Thus, the kit of the present invention will instruct the consumer to consume (i.e., within about ten (10) minutes, and preferably, within about five (5) minutes) a predetermined volume (serving) of energy-delivering beverage that comprises from about 15.0 grams to about 30.0 grams of dextrose, and preferably, from about 18.0 grams to about 22 grams of dextrose. It is also noted herein that the energy-delivering beverage of the present invention may be packaged in packaging typically used in the beverage industry. Such packaging includes aluminum cans, glass bottles, plastic (e.g., polyethylene terephthalate) bottles and those generally classified as tetrapak or tetrabrick packages.

The following examples are provided to illustrate and facilitate an understanding of the present invention. The examples are not intended to limit the scope of the claims.

### EXAMPLE 1

Berry-tasting energy-delivering beverages were prepared by mixing, in no particular order, the beverage components described below and about 9.0% of the total weight percent of the water (at about 69° C.) to produce beverage premixes. The resulting beverage premixes were combined with remaining water (at about 4.0° C.) to produce mixtures that were carbonated with about 1.0 liter of carbon dioxide (for every liter of mixture) to produce berry-tasting energy-delivering beverages.

| BEVERAGE COMPONENT | WEIGHT PERCENT |
|---|---|
| Dextrose | 6.5-7.5 |
| Raspberry Concentrate | 1.0-2.0 |
| High Fructose Corn Syrup | 3.0-4.0 |
| Citric Acid | 0.05-0.08 |
| Malic Acid | 0.05-0.15 |
| Blackberry Concentrate | 0.30-0.60 |
| Berry Flavor | 0.1-0.2 |
| Ascorbic Acid | 0.025-0.04 |
| B-Complex Mixture* | 0.005-0.008 |
| Pear Juice Concentrate | 2.0-3.0 |
| Preservative | 0.08-0.12 |
| Water | Balance |

*as made commercially available by Roche Vitamins, Inc.

### EXAMPLE 2

Citrus-tasting energy-delivering beverages were made in a manner similar to the one described in Example 1 except that in lieu of the beverage components used in Example 1, the following beverage components were used.

| BEVERAGE COMPONENT | WEIGHT PERCENT |
|---|---|
| Dextrose | 7.0-8.0 |
| Citrus Concentrate Mixture | 2.0-3.0 |
| High Fructose Corn Syrup | 3.5-4.5 |
| Citric Acid | 0.1-0.2 |
| Lemon Lime Orange Flavor | 0.1-0.2 |
| Ascorbic Acid | 0.03-0.04 |
| B-Complex Mixture* | 0.006-0.008 |
| Pear Juice Concentrate | 2.0-3.0 |
| Preservative | 0.08-0.12 |
| Water | Balance |

*as made commercially available by Roche Vitamins, Inc.

### EXAMPLE 3

Beverages, similar to those made in Examples 1 and 2, were given to ten (10) panelists, along with a commercially available energy-delivering, electrolyte-comprising (popular) sports drink.

The ten panelists were recruited on two consecutive days and instructed not to consume any beverages after having lunch. The product of this invention (beverage A) and the popular sports drink (beverage B) were not labeled when given to the panelists.

On the first day of the panel, at around 3 p.m., the panelists were asked to rate how they felt (prior or to consuming beverage) on a visual analogue scale of ten (10) centimeters, with parameters set at “not at all” to “very” and terms set at thirsty, refereshed, energized and alert. Five (5) of the panelists were then given a serving of the product of this invention and the other five (5) panelists were given a serving of the popular sports drink. The panelists were instructed to consume the beverages within five (5) minutes.

About fifteen (15) minutes after consuming the beverages, the panelists were asked to rate how they felt (after consuming the beverage) on a visual analogue scale of 10 centimeters, with parameters set at “not at all” to “very” and terms set at thirsty, refreshed, energized and alert. On the second day the same procedure was repeated except that the panelists consumed the beverage that they did not consume on the first day.

The ratings were measured with a ruler and the resulting data was analyzed as follows: for product A the difference between “after consumption” and “before consumption” for each of the four parameters: AA. The same was done for product B: AB. Product A was compared with product B by applying a paired t-test to the ΔA and ΔB values. The Table depicts, for each of the four parameters, the average difference between products A and B (ΔB-ΔA), the Standard Deviation for the difference and the p-value of the t-test.

| Difference between B and A | Thirsty | Refreshed | Energized | Alert |
|---|---|---|---|---|
| Average (cm) | −0.1 | −1.0 | −0.2 | −0.2 |
| SD | 3.5 | 3.1 | 2.7 | 2.5 |
| P (paired T-test) | 0.965 | 0.359 | 0.805 | 0.814 |

The results unexpectedly show that the energy-delivering beverage of the present invention is at least as energy-enhancing as commercially available sports drinks having significant levels of electrolytes.

### EXAMPLE 4

Flavor/taste panels were conducted by providing panelists with samples of the energy-delivering beverage of this invention and the commercially available sports drink described in the examples above. The results of the panels indicate that about two thirds (⅔) of the panelists preferred the taste of the energy-delivering beverage of the present invention.

The results from the examples above unexpectedly show that the energy-delivering beverage of the present invention is at least as energy-delivering as conventional sports drinks, yet better tasting.

What is claimed is:

1. An energy-delivering beverage comprising:
(a) from about 4.0% to about 25.0% by weight of a dextrorotatory saccharide;
(b) at least about 30.0% by weight of at least one concentrate selected from the group consisting of a tea, coffee, fruit and vegetable concentrate, the concentrate not to exceed an amount that makes the energy-delivering beverage more than about 85.0% by weight coffee liquid, tea liquid, fruit juice or vegetable juice;
(c) an effective amount of carbon dioxide to carbonate the beverage, the effective amount of carbon dioxide not to exceed 3.0 liters of carbon dioxide for about every 1.0 liter of beverage; and
(d) a mixture of vitamins comprising at least about 10.0% of the recommended daily allowance of B complex vitamins and at least about 10.0% of the recommended daily allowance of a water soluble vitamin
wherein the energy-delivering beverage comprises an energy factor of about ≧250.0.

2. The energy-delivering beverage according to claim 1 wherein the beverage comprises tea concentrate.

3. The energy-delivering beverage according to claim 1 wherein the beverage comprises coffee concentrate.

4. The energy-delivering beverage according to claim 1 wherein the beverage comprises fruit concentrate.

5. The energy-delivering beverage according to claim 1 wherein the beverage comprises vegetable concentrate.

6. The energy-delivering beverage according to claim 1 wherein the beverage comprises less than about 5.0% by weight of an electrolyte.

7. The energy-delivering beverage according to claim 1 wherein the dextrorotatory saccharide is dextrose.

8. The energy-delivering beverage according to claim 1 wherein the leverage comprises at least about 30.0% by weight coffee liquid, tea liquid; fruit juice or vegetable juice.

9. The energy-delivering beverage according to claim 1 wherein the beverage comprises at least about 20.0% by weight of the recommended daily (allowance of B-complex vitamins.

10. The energy-delivering beverage according to claim 1 wherein the beverage comprises from about 90.0% to about 100.0% of the recommended daily allowance of ascorbic acid.

11. The energy-delivering beverage according to claim 8 wherein the beverage is at least about 30.0% by weight fruit juice.

12. A kit for providing an energy boost to a consumer, the kit comprising:
(i) an energy-delivering beverage having an energy factor of about ≧250.0 and comprising:
(a) from about 3.0% to about 25.0% by weight of a dextrorotatory saccharide;
(b) at least about 10.0% by weight of at least one concentrate selected from the group consisting of a tea, coffee, fruit and vegetable concentrate, the concentrate not to exceed an amount that makes the energy-delivering beverage more than about 85.0% by weight coffee liquid, tea liquid, fruit juice or vegetable juice;
(c) an effective amount of carbon dioxide to carbonate the beverage, the effective amount of carbon dioxide not to exceed 3.0 liters of carbon dioxide for about every 1.0 liter of beverage;
(d) a mixture of vitamins comprising at least about 10.0% of the recommended daily allowance of B complex vitamins and at least about 10.0% of the recommended daily allowance of a water soluble vitamin; and
(ii) instructions to consume the energy-delivering beverage between meals and to consume a serving that results in an intake of about 15.0 grams to about 30 grams of dextrorototary saccharide for a maximum energy boost.

13. A kit for providing an energy boost to a consumer according to claim 12 wherein the energy-delivering beverage of the kit is at least about 30.0% by weight fruit juice.

14. A kit for providing an energy boost to a consumer according to claim 12 wherein the energy-delivering beverage of the kit comprises less than about 5.0% by weight of an electrolyte.

15. A kit for providing an energy boost to a consumer according to claim 12 wherein the energy-delivering beverage of the kit comprises at least about 20.0% by weight of the recommended daily allowance of B-complex vitamins.

16. A kit for providing an energy boost to a consumer according to claim 12 wherein the energy-delivering beverage of the kit is not pasteurized.

17. A kit for providing an energy boost to a consumer according to claim 12 wherein the energy-delivering beverage of the kit is pasteurized.
